(19) United States
(12) Patent Application Publication
(10) Pub. No.: US 2016/0094914 A1
(43) Pub. Date: Mar. 31, 2016

(54) SYSTEMS AND METHODS FOR LOCALIZING AUDIO STREAMS VIA ACOUSTIC LARGE SCALE SPEAKER ARRAYS

(71) Applicant: Alcatel-Lucent USA Inc., Murray Hill, NJ (US)

(72) Inventors: Iraj SANIEE, New Providence, NJ (US); Thomas MARZETTA, Summit, NJ (US)

(73) Assignee: ALCATEL-LUCENT USA INC., Murray Hill, NJ (US)

(21) Appl. No.: 14/502,058

(22) Filed: Sep. 30, 2014

(51) Int. Cl. H04R 3/12

(52) U.S. Cl. CPC H04R 3/12; H04R 2201/403

(57) ABSTRACT

In one example embodiment, a system for localizing an audio stream includes a processor. The processor is configured to determine channel state information of an acoustic channel between a plurality of speakers and at least one device of a plurality of devices, the at least one device requesting the audio stream from among available audio streams. The processor is further configured to determine transmit signals for transmitting audio signals representing the available audio streams to the plurality of devices, the determined transmit signals being based on at least the determined channel state information such that the requested audio stream is more audible to a user associated with the at least one device compared to other users associated with other ones of the plurality of devices.

### BACKGROUND

Given the differing interests of various users (e.g., ordinary people such as pedestrians, shoppers, etc.) in public spaces such as malls, gyms, museums and airport lounges, the possibility of personalizing a desired one of various available audio streams to listen to, is appealing. For example, in an airport lounge or a gym where many screens broadcast different channels, different patrons may wish to listen to different audio streams associated with different channels. One patron may wish to listen to an audio stream associated with a screen broadcasting the latest news while another patron may wish to listen to another audio stream associated with a screen broadcasting the latest sporting event. In other words, different patrons may wish to have different personalized audio streams.

The current solution for providing personalized audio stream involves the use of headphones which need to be plugged into a source with appropriate input signal or a channel broadcasting the relevant sound. The current solutions require physical devices, capable of receiving audio streams, to be attached to the head or ears of a user. Utilizing the current solutions in large public spaces is not desirable as physical (e.g. hardwire) connection between headphones of different users and the sources of different audios is often inconvenient to the end user and to implement. The example embodiments of the present application, as will be described below, provide an all-acoustic and more practical alternative to the current state of the art.

### SUMMARY

Some example embodiments relate to methods and/or systems for localizing audible audio streams so that different users in a common public space can listen to any one the audio streams without using headphones and without hearing other audio streams.

In one example embodiment, a system for localizing an audio stream includes a processor. The processor is configured to determine channel state information of an acoustic channel between a plurality of speakers and at least one device of a plurality of devices, the at least one device requesting the audio stream from among available audio streams. The processor is further configured to determine transmit signals for transmitting audio signals representing the available audio streams to the plurality of devices, the determined transmit signals being based on at least the determined channel state information such that the requested audio stream is more audible to a user associated with the at least one device compared to other users associated with other ones of the plurality of devices.

In yet another example embodiment, the processor is configured to send the determined transmit signals to the plurality of speakers for transmission to the plurality of devices.

In yet another example embodiment, each of the plurality of speakers transmits the audio signals corresponding to the available audio streams.

In yet another example embodiment, the processor is configured to determine the transmit signals by determining pre-codes based on the determined channel state information and applying the determined pre-codes and transmission power coefficients to the audio signal to determine the transmit signals.

In yet another example embodiment, the processor is configured to determine the pre-codes based on one of conjugate beamforming or zero-forcing beamforming.

In yet another example embodiment, the processor is configured to determine the channel state information by measuring a channel impulse response between each of the plurality of speakers and the at least one device.

In yet another example embodiment, the processor is configured to measure the channel impulse response by receiving from each of the plurality of speakers, an acoustic training signal transmitted by the at least one device and received at each of the plurality of speakers.

In yet another example embodiment, the acoustic training signal transmitted by the at least one device and other acoustic training signals transmitted by other ones of the plurality of devices are mutually orthogonal.

In yet another example embodiment, the processor is further configured to detect a presence of the at least one device in a setting in which the plurality of speakers are installed.

In yet another example embodiment, the processor is configured to detect the presence of the at least one device by receiving a request for the audio stream from the at least one device.

In one example embodiment, a method for localizing an audio stream includes determining channel state information of an acoustic channel between a plurality of speakers and at least one device of a plurality of devices, the at least one device requesting the audio stream from among available audio streams. The method further includes determining transmit signals for transmitting audio signals representing the available audio streams to the plurality of devices, the determined transmit signals being based on at least the determined channel state information such that the requested audio stream is more audible to a user associated with the at least one device compared to other users associated with other ones of the plurality of devices.

In yet another example embodiment, the method further includes sending the determined transmit signals to the plurality of speakers for transmission to the plurality of devices.

In yet another example embodiment, each of the plurality of speakers transmits the audio signals corresponding to the available audio streams.

In yet another example embodiment, the determining the transmit signals determines the transmit signals by determining pre-codes based on the determined channel state information and applying the determined pre-codes and transmission power coefficients to the audio signal to determine the transmit signals.

In yet another example embodiment, the determining the pre-codes determines the pre-codes based on one of conjugate beamforming or zero-forcing beamforming.

In yet another example embodiment, the determining the channel state information determines the channel state information by measuring a channel impulse response between each of the plurality of speakers and the at least one device.

In yet another example embodiment, the measuring measures the channel impulse response by receiving from each of the plurality of speakers, an acoustic training signal transmitted by the at least one device and received at each of the plurality of speakers.

In yet another example embodiment, the acoustic training signal transmitted by the at least one device and other acoustic training signals transmitted by other ones of the plurality of devices are mutually orthogonal.

In yet another example embodiment, the method further includes detecting a presence of the at least one device in a setting in which the plurality of speakers are installed.

In yet another example embodiment, the detecting detects the presence of the at least one device by receiving a request for the audio stream from the at least one device.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present disclosure, and wherein:

FIG. 1 depicts a system for localizing audio in a setting, according to an example embodiment;

FIG. 2 depicts a system for localizing audio in another setting, according to an example embodiment;

FIG. 3 describes a flowchart of a method for localizing audio streams, according to an example embodiment;

FIG. 4 describes a method for determining channel state information for an acoustic channel between a device and a plurality of speakers, according to an example embodiment; and

FIG. 5 describes a flowchart of a method for localizing audio streams, according to an example embodiment.

### DETAILED DESCRIPTION OF EXAMPLE EMBODIMENTS

Various embodiments will now be described more fully with reference to the accompanying drawings. Like elements on the drawings are labeled by like reference numerals.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,’ or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs), computers or the like.

Although a flow chart may describe the operations as a sequential process, many of the operations may be performed in parallel, concurrently or simultaneously. In addition, the order of the operations may be re-arranged, and certain operations may be omitted or added to the process. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware, or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory content. Information, arguments, parameters, data, etc. may be passed, forwarded, or transmitted via any suitable means including memory sharing, message passing, token passing, network transmission, etc.

As will be described below, the example embodiments of the present application enable different users in a given public space to listen to (e.g., personalize) one of a plurality of different available audio streams without using headphones. The example embodiments enable localization and personalization of acoustic signals in an immediate vicinity of one or more individual users (e.g., listeners) among a large number of individuals present in a given public space.

This localization and personalization of acoustic signals is enabled by creating sufficient coherent sound energy in the immediate vicinity of a user by aggregating a number of low energy audio signals transmitted from a large speaker array in the immediate vicinity of the user. In other words, while all audio signals associated with different audio streams are transmitted to all users in a given public space, depending on a desired/requested audio stream by any of the users in the public space, the low energy audio signals corresponding to the desired/requested audio stream are selectively aggregated in the vicinity of a requesting user while the other low energy audio signals of non-desired/non-requested audio streams are not aggregated and thus may at most appear as background noise to the requesting user.

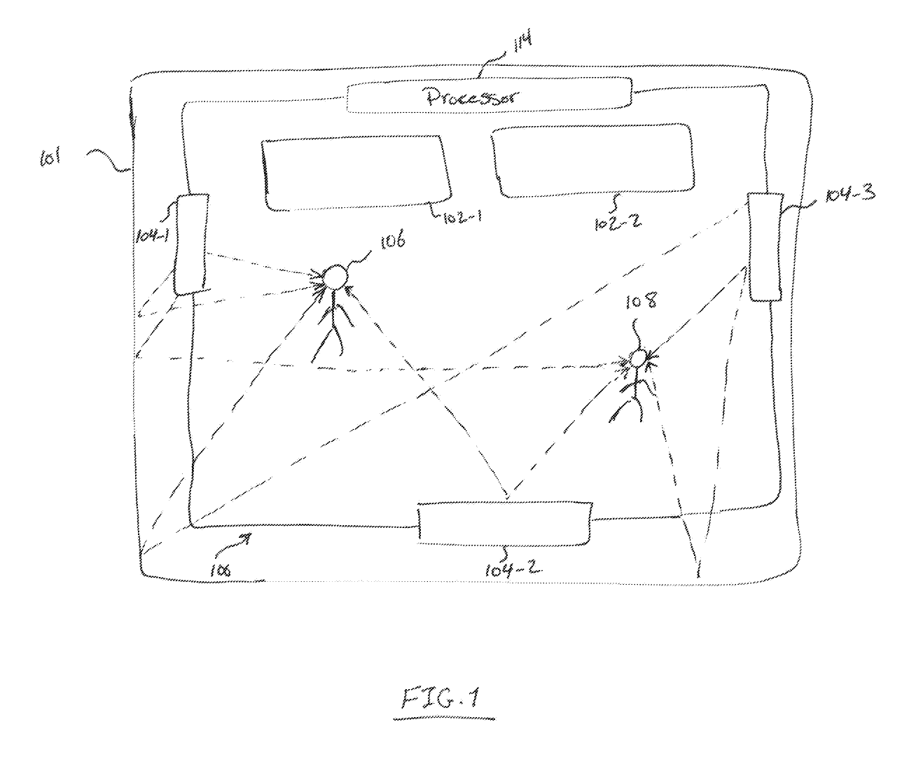

FIG. 1 depicts a system for localizing audio in a setting, according to an example embodiment. The system 100 may be deployed in a setting 101, which may be any one of, but not limited to, an airport lounge, a gym, a sports bar, a museum and a mall. The system 100 may include a number of video sources 102-1 and 102-2, each of which may be a large screen TV, a projection screen, etc. Hereinafter, the video sources 102-1 and 102-2 may simply be referred to as screens 102-1 and 102-2. The number of the screens is not limited to that shown in FIG. 1, but may range from 1 to many. In one example embodiment, each of the screens 102-1 and 102-2 broadcast a different video source (e.g., a sporting event, news, a movie, a music video, etc.).

The system 100 may further include a number of speakers 104-1 to 104-3. The speakers 104-1 to 104-3 may be referred to as speaker array 104. The number of speakers in the speaker array 104 is not limited to that shown in FIG. 1 but may range from a few speakers to hundreds of speakers. The speakers of the speaker array 104 may be installed at various locations within the setting 101. For example, the speakers of the speaker array 104 may be installed on the surrounding walls of the setting 101, within seating arrangements in the setting 101 (e.g., couches within the airport lounge), etc.

The speakers of the speaker array 104 may each include electrical components such as a transducer, a digital-to-analog converter and an analog-to-digital converter for communication with users present in the setting and/or a central processor, both of which will be described below. The speakers of the speaker array 104 may further include a microphone for receiving signals (e.g., acoustic signals) from users.

The speakers of the speaker array 104 may be positioned near one another or may alternatively be positioned up to a few hundred feet apart. Each of the speakers of the speaker array 104 may broadcast the audio signals associated with the screens 102-1 and 102-2. The connection between the speakers of the speaker array 104 and the corresponding screen of the screens 102-1 and 102-2 may be a wired connection or a wireless connection.

Furthermore, there may be several users 106 and 108 present in the system 100. The number of users is not limited to that shown in FIG. 1 but may range from one to as many as could fit in the setting 101. Each of the users 106 and 108 may wish to listen to a different one of the audio streams. In one example embodiment, the user 106 may wish to listen to an audio stream associated with the screen 102-1 and the user 108 may wish to listen to an audio stream associated with the screen 102-2.

As shown in FIG. 1, each speaker of the speaker array 104 may broadcast audio signals that, regardless of the path taken, may eventually reach every user present in the setting 101. For example, as shown by the broken lines in FIG. 1, the acoustic signals associated with the audio streams of the screens 102-1 and 102-2 transmitted by the speakers 104-1 to 104-3 of the speaker array 104, may take different paths to reach each of the users 106 and 108. For example, the acoustic signals transmitted by the speakers 104-1 to 104-3 may directly reach the users 106 and 108, while it may bounce off of any one of the walls/roof/floor of the setting 101, other users, speakers and/or other objects present in the setting 101 to reach one or more of the users 106 and 108.

As will be described below, the users 106 and 108 may each have an associated portable device (e.g., a mobile device such as a cellular phone, a tablet, a portable computer, a pager or any other electronic device capable of communicating with the speakers of speaker array 104), with which the speaker array 104 communicates to receive acoustic channel state information (CSI) between each of the users 106 and 108 and each of the speakers of the speaker array 104. The received CSI(s) will then be transmitted to a processor 114, which will be described below. The processor 114 determines an appropriate pre-codes/gain matrix using the received CSI, with which the audio signals of the available audio streams may be multiplied and then transmitted by each speaker of the speaker array 104 to the users 106 and 108.

The portable devices associated with the users 106 and 108 may include at least a processor, a speaker, a microphone, a transducer, an analog-to-digital converter and a digital-to-analog converter for communication with the speakers of the speaker array 104. Hereinafter and throughout the specification, the terms user device, portable device and user may be used interchangeably.

The users 106 and 108 may enter or leave the setting 101 at any time and/or may move around within the setting 101. As will be described below, depending on the amount of movement within the setting 101, a particular user's CSI may change and may thus need to be measured again/updated.

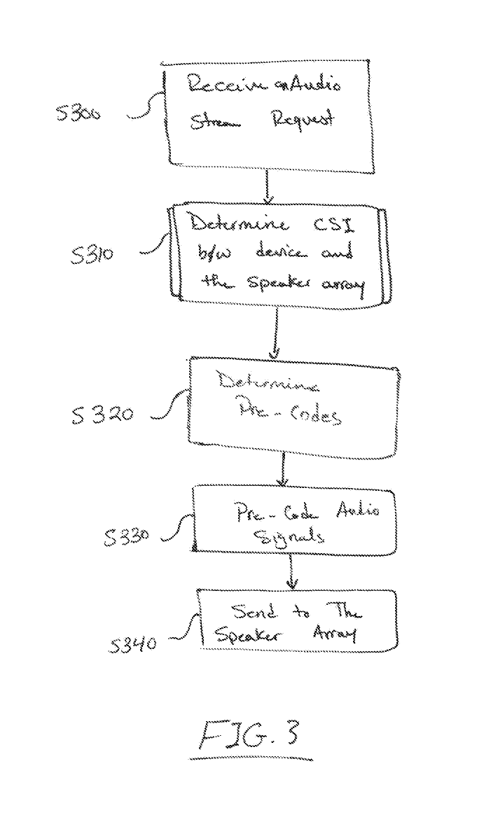

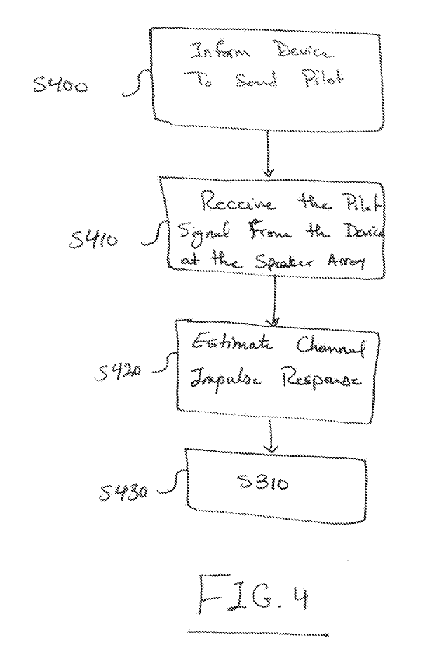

As shown in FIG. 1, the system 100 may further include a processor 114. The speakers of the speaker array 104 may communicate with the processor 114, where the processor 114 is a special purpose processor implementing the method described below with respect to FIGS. 3-4. The communication between the processor 114 and the speakers of the speaker array 104 may be carried out via a wireless communication link or a wired communication link.

In one example embodiment and by implementing the method of FIGS. 3-4, the processor 114 may enable the speakers 104-1 to 104-3 to broadcast the audio streams associated with the screens 102-1 and 102-2 in such a manner that only a desired audio stream from among available audio streams is audible to a user. In one example embodiment, the user 106 may desire to listen to the audio stream associated with the screen 102-1. While speakers 104-1 to 104-3 each broadcast audio signals for all of the audio streams associated with the screens 102-1 and 102-2, the method of FIGS. 3-4 enable the user 106 to only hear the audio stream associated with the screen 102-1, while other audio streams associated with the screen 102-2 may be completely inaudible to the user 106 or may at most amount to background noise to the user 106. Similarly, the method of FIGS. 3-4 enable user 108 to only hear the audio stream associated with the screen 102-2 while other audio streams may be completely inaudible to the user 108 or may at most amount to background noise to the user 108.

In one example embodiment, the speakers of the speaker array 104 may individually be configured to cooperatively carry out the process described below with respect to FIGS. 3-4 and thus there would be no need for the processor 114 as each speaker of the speaker array 104 may have a separate processor associated therewith (e.g., the speakers of the speaker array 104 perform decentralized processing). In this example embodiment, the individual speakers may communicate with each other via a wireless communication link or a wired communication link, as shown in FIG. 1.

In one example embodiment, the setting, as mentioned above, may be a museum or a window display of a clothing store in a shopping mall. Accordingly, the screens 102-1 and 102-2 may not necessarily broadcast videos but may rather correspond to different sculptures, paintings, items displayed for sale, etc., each of which may have an audio stream associated therewith. The associated audio stream may describe the story behind a given sculpture or painting or describe the characteristics of the items displayed for sale. As patrons walk around the museum or the store, they may wish to listen to a particular audio stream associated with a particular item on display without using headsets or hearing other available audio streams. The example embodiments and the methods described below enable a patron to do so.

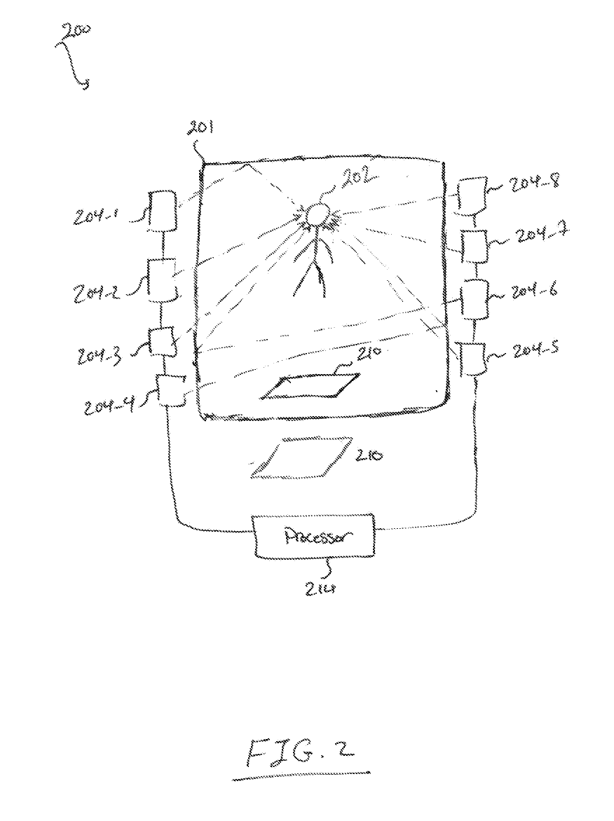

FIG. 2 depicts a system for localizing audio in another setting, according to an example embodiment. The system 200 may be utilized in a setting 201. The setting 201 may be any one of, but not limited to, an entrance of a shopping mall or of a particular store in a shopping mall, an entrance to a gym or an entrance to a museum.

The system 200 may include a number of speakers 204-1 to 204-8. The speakers 204-1 to 204-8 may be referred to as speaker array 204. The speaker array 204 may function in the same manner as the speaker array 104. The number of speakers in the speaker array 204 is not limited to that shown in FIG. 2 but may range from a few speakers to hundreds of speakers.

In one example embodiment, the speaker array 204 may be placed around or within the setting 201 of a shopping mall, a particular store in a shopping mall, an entrance of a gym, an entrance to a museum, etc. The speaker array 204 may broadcast a particular audio (e.g., a song, an advertisement, a welcoming message, etc.), that may only be audible as an individual 202 (e.g., a patron, a customer, etc.) passes through such entrance 201 but may not be audible a few feet from the entrance.

While in FIG. 2, the setting 201 has been described as an entrance, in one example embodiment, the setting 201 may be a particular item on display at a museum or in a clothing store in a shopping mall, where different items such as sculptures, paintings, jewelry, clothes, etc., may have an audio stream associated therewith. Accordingly, the audio stream of each item may only be audible to patrons that are located within limited geographical area surround each item (e.g., a few feet from such item). The audio stream associated with each item, depending on the type of the item, may describe the story behind a given sculpture or painting or describe the characteristics of the items displayed for sale.

As shown in FIG. 2, the system 200 may further include a processor 214. The speakers of the array 204 may communicate with the processor 214, where the processor 214 is a special purpose processor implementing the method described below with respect to FIGS. 3-4. In one example embodiment and by implementing the method of FIGS. 3-4, the processor 214 may enable the speakers 204-1 to 204-8 to broadcast the intended audio stream (e.g., a song, an advertisement, a welcoming message, etc.) to the individual 202 (e.g., a patron or a customer) passing through an entrance or positioned within a few feet of an item on display. The communication between the processor 214 and the speakers of the speaker array 204 may be carried out via a wireless communication link or a wired communication link.

In one example embodiment, the speakers of the speaker array 204 may individually be configured to carry out the process described below with respect to FIGS. 3-4 and thus there would be no need for the central processor 214 as each speaker of the speaker array 204 may have a separate processor associated therewith (e.g., the speakers of the speaker array 104 perform decentralized processing). In this example embodiment, the individual speakers may communicate with each via a wireless communication link or a wired communication link, as shown in FIG. 2.

In the example embodiments described with respect to FIG. 2 and unlike in FIG. 1, the patrons may not need to carry a portable device to communicate with the speakers of the speaker array 204. Therefore, the system 200 may not include such portable devices. Instead, devices such as 210 may be fixedly positioned in the setting 201 (e.g., within a few feet of the entrance to the mall, within a few feet of an item in the museum, etc.). The device 210 may include a receiver/microphone for receiving instructions to transmit pilot signals as well as transmitting pilot signals to the speakers of the speaker array 204. The speakers of the speaker array 204 may communicate with the fixedly positioned devices 210 for acoustic channel estimation purposes and broadcasting of audio signals. The number of devices 210 is not limited to that shown in FIG. 2.

As shown by the broken lines in FIG. 2, each of the speakers of the speaker array 204 may transmit audio signals of the intended audio stream to the individual 202, where each of the audio signals may take on a different path to arrive at the individual 202. For example, as shown in FIG. 2, the audio signal from the speaker 204-1 may bounce off walls of the setting 201 before reaching individual 202, while other signals (e.g., audio signal from the speaker 204-3) may reach the individual 202, directly. The same alternative paths may be taken by each audio signal transmitted by each speaker of the speaker array 204 to reach the individual 202.

Hereinafter, a method for localizing/personalizing audio, to be implemented by the processors and/or individual speakers described above with reference to FIGS. 1-2, will be described.

FIG. 3 describes a flowchart of a method for localizing audio streams, according to an example embodiment. For ease of description, the description provided below will be described with reference to processor 114. However, the same may be implemented by the processor 214 or individual speakers of the speaker arrays 104 and 204.

At S300, the processor 114 receives a request for an audio stream from a user (e.g., user 106 and/or 108) via the speaker array 104 in for example, the setting shown in FIG. 1. In the example embodiment of FIG. 2, S300 may not be performed as the audio stream is a single audio stream that may continuously be broadcasted within a few feet of the associated item, entrance, etc.

In one example embodiment and within the setting shown in FIG. 1, the processor 114 may receive a request for an audio stream as follows.

The user may have a mobile device (e.g., the portable device described above) associated therewith. The mobile device may have an application running thereon, which detects a presence of available audio streams within the setting shown in FIG. 1. For example and in the same manner as to how a mobile device detects available Wi-Fi services in a given location, the mobile device associated with the user may detect the available audio streams once the user enters the setting in FIG. 1, setting 201 in FIG. 2 or any other setting in which the example systems 100 or 200 are implemented.

For example, in the setting shown in FIG. 1, where screens 102-1 and 102-2 each broadcast different videos, a list of two available audio streams may pop up on the user's mobile device, each of which corresponds to one of the screens 102-1 and 102-2. The user may click on any one of the audio streams on the list, which the user may wish to listen to.

At S310, the processor 114 may determine channel state information (CSI) of an acoustic channel between the user's mobile device and the speakers of the speaker array 114 that broadcasts the chosen audio stream. The process of determining the CSI will now be described with reference to FIG. 4.

FIG. 4 describes a method for determining channel state information for an acoustic channel between a device and a plurality of speakers, according to an example embodiment.

At S400, the processor 114 may direct/inform the mobile device associated with the user to send a pilot signal (which may also be referred to as an acoustic and/or audio training signal) to the speakers of the speaker array 104. In one example embodiment, the processor 114 may direct/inform the user's mobile device to transmit the pilot signal via a conventional wireless link or a free-space optical link.

Upon receiving an indication, the mobile device of the user may transmit the pilot signal to each of the speakers of the speaker array 104. At S410, the processor 114 may receive the pilot signal from the mobile device of the user via each speaker of the speaker array 104.

At S420, the processor 114 determines the CSI as an estimate of the impulse response of each of the acoustic channels between the mobile device of the user and each of the speakers of the speaker array 114, over which the mobile device of the user transmitted the pilot signal to each speaker of the speaker array 104. In one example embodiment, the channel impulse response may be denoted as gₘₖ(t), where m denotes the mth speaker of the speaker array 104 and k denotes the k^{th} user.

For purposes of discussion, we assume in general that there are M speakers in a speaker array and K users present in a setting. Therefore, in the example embodiment of FIG. 1, M is 3 and K is 2. Accordingly and in matrix form, the channel impulse response may be a matrix of MxK dimensions denoted by G.

The processor 114 may determine each of the acoustic channel impulse responses using any known channel impulse response estimation methods.

The process of FIG. 4 based on which the processor 114 determines the acoustic channel CSI, may be referred to as a training interval. In one example embodiment, there may be more than one user for which the processor 114 should determine a corresponding CSI and subsequently send a requested audio stream to each user. Accordingly, because mobile devices associated with users are peak power-limited, in one example embodiment, all interested users advantageously transmit pilot signals simultaneously throughout the training interval. In one example embodiment, in order for the processor 114 to distinguish among the different pilot signals of different users, the pilot signals are mutually orthogonal over intervals of frequency such that the acoustic channel frequency responses are approximately constant.

Significant correlation among pilot signals transmitted by different users may result in what is known as pilot contamination. For example, when two users transmit the same pilot signals, the processor 114 may process the received pilot signal by obtaining a linear combination of the two acoustic channels of the two users. Accordingly, when the processor 114 uses linear pre-coding to transmit an audio signal to a first one of the two users, it may inadvertently direct the speakers of the speaker array 104 to transmit the same audio signal to the second user, and vice-versa. Thus pilot contamination results in coherent directed interference that may only worsen as the number of the speakers of the speaker array 104 increases.

Accordingly and in one example embodiment, such pilot contamination may be utilized for multicasting, in which the same audio signal is to be transmitted to a multiplicity of users (e.g., when more than one user in the setting requests the same audio signal. For example, users 106 and 108 in FIG. 1 request the audio stream for the screen 102-1). For multicasting, the processor 114 may assign mutually orthogonal pilot sequences, not to individual users, but rather to the audio signals.

Furthermore and in one example embodiment, the training interval is performed every time a new user enters the setting 100. In yet another example embodiment, whenever the user moves significantly (e.g., more than ¼ of a wavelength), the training interval for such user is renewed. In yet another example embodiment, when the acoustic conditions in the setting changes (e.g., due to the movement of people, vehicles, etc.), the training interval for such user and/or setting is renewed.

At S430, the processor may revert back to S310 of FIG. 3.

Referring back to FIG. 3, using the determined CSI information of the channels between the user and each of the speakers of the speaker array, the processor 114 may determine transmit signals for transmitting audio signals corresponding to audio streams associated with the screens 102-1 and 102-2 to the users 106 and 108. Hereinafter, the processor of determining the transmit signals will be described with reference to S320 to S340.

At S320, the processor 114 determines pre-codes for pre-coding audio signals of the audio stream. In one example embodiment, the processor 114 determines pre-codes for pre-coding audio signals of all the available audio streams that are transmitted by all of the speakers of the speaker array 104. In one example embodiment, the processor 114 may determine the pre-codes as follows.

There may be two different forms of pre-coding referred to as conjugate beam-forming and zero-forcing. The conjugate beam-forming and the zero-forcing pre-coding are respectively shown by the following:

A(f)=\hat{G}*(f), (1)

A(f)=Ĝ*(f)(Ĝ^{T}(f)\hat{G}*(f))⁻¹ (2)

Given the channel impulse response estimate matrix G., as determined at S420, in one example embodiment, the processor 114 determines the pre-code matrix A, per Eq. (1) or (2) above.

Once the processor 114 determines the pre-codes, at S330, the processor 114 pre-codes the audio signals of the available audio stream(s) and determines the transmit signals (which may refer to audio signals determined for transmission) to be communicated to the speakers of the speaker array 104 for transmission to the users 106 and 108. In one example embodiment, the processor 114 determines the transmit signals with the following assumptions taken into consideration.

As described above, there are K users and M speakers and the audio signal associated with the audio stream requested by the k-th user, is denoted as qₖ(f) in frequency domain. Then, the K intended audio signals are mapped into the M signals transmitted by the speaker array 104 via, for example, a linear pre-coding operation..

The transmit signals may be designated as xₖ(f) in frequency domain, which may in turn be sent to the speakers of the speaker array 104, for subsequent transmission to the users 106 and 108. The signal x(f), in matrix form and in frequency-domain representation, may be determined as follows:

x(f)=A(f)D_{η}q(f), (3)

where D_{η} is a KxK diagonal matrix of power-control coefficients which denotes the power with which each speaker of the speaker array 104 transmits an acoustic signal. D_{η} is not frequency dependent. A(f) is a MxK pre-coding matrix determined at S320 and q(f) is a vector of audio signals of all the available audio streams (e.g., the audio signals of all the available audio streams for screens 102-1 and 102-2.

Knowing A(f), D_{η} and q(f), at S330, the processor 114 determines the transmit signals x(f), per Eq. 3.

The performance of linear pre-coding improves monotonically with the number of speakers in the speaker array 104. The ability to transmit audio selectively to the multiplicity of users improves, and the total radiated power required for the multiplexing is inversely proportional to the number of speakers in the speaker array 104.

In some example embodiments, pre-coding based on zero-forcing tends to be superior to pre-coding based on conjugate beamforming when performance is noise limited (rather than interference limited) and the users enjoy high Signal to Interference and Noise Ratios (SINRs). While zero-forcing may require a higher computational burden than conjugate beamforming, the implementation of linear pre-coding of Eq. 3 based on conjugate beam-forming may require more total effort than the computation of the linear pre-coding of Eq. 3 based on zero-forcing. An example advantage of conjugate beamforming over zero-forcing in that conjugate beamforming permits decentralized array architecture such that every speaker performs its own linear pre-coding independent of the other transducers. In other words, instead of utilizing a centralized processor 114, as shown in FIG. 1, each of the speakers of the speaker array 114, via an associated processor, may perform the method of FIGS. 3-4 between itself and the user(s) in the setting.

At S340, the processor 114 may send the transmit signal x determined according to Eq. 3 above, to the speakers of the speaker array 104 for transmission to the users 106 and 108. The transmit signal x may be received at the users 106 and 108 as y, which may be represented in the frequency domain as:

y(f)=G^{T}(f)x(f). (4)

where “T” denotes a transpose of the channel impulse response matrix G, as estimated and described above. Eq. (4) may be converted to time-domain, in which case y may be a convolution of G^{T}(t) and x(t).

In one example embodiment and as described above, the pre-coded audio signals (e.g., the entries of the transmit signal matrix x) are low-energy acoustic signals that are transmitted over the air such that the low energy audio signals corresponding to the screen 102-1 aggregate in a vicinity of the user 106. Accordingly, the audio stream associated with the screen 102-1 will have an energy level above a threshold and is audible to the user 106 while the audio stream associated with the screens 101-2 is inaudible or are less audible to the user 106 (e.g. appear as background noise).

Similarly, the low energy audio signals corresponding to the audio stream associated with the screen 102-2 aggregate in a vicinity of the user 108. Accordingly, the audio stream associated with the screen 102-2 will have an energy level above a threshold and is audible to the user 108 while the audio stream associated with the screens 102-1 is inaudible or are less audible to the user 106 (e.g. appear as background noise).

In one example embodiment, the threshold described above is a configurable parameter and may correspond to a threshold above which sound is audible to a human ear.

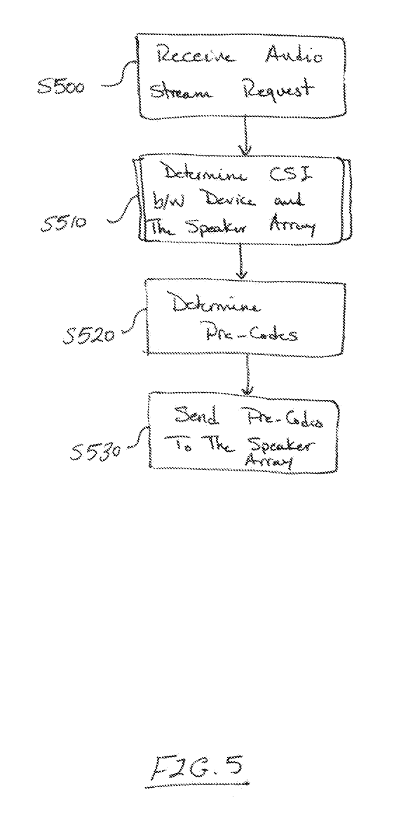

In one example embodiment, the processor 114 may determine the pre-codes but the process of pre-coding the audio signals may be performed by processors associated with the speakers of the speaker array 104. This example embodiment will be described with reference to FIG. 5, below. The processors each of which is associated with one of the speakers of the speaker array 104 may be embedded within a physical structure of each speaker of the speaker array 104.

FIG. 5 describes a flowchart of a method for localizing audio streams, according to an example embodiment. The process at S500 may be performed by the processor 114 (or processor 214 or the speakers of the speaker array 104/204), in the same manner as S300 described above with reference to FIGS. 3-4. Similarly, the process at S510 may be performed in the same manner as S310 described above with reference to FIGS. 3-4. Furthermore, the processor at S520 may be performed in the same manner as S320 described above with reference to FIG. 3.

At S530, the processor 114 may send the pre-codes determined at S520 to the speakers of the speaker array 104.

Thereafter, the speakers, via their associated processors, perform the pre-coding in the same manner as that done at S330 as described above with reference to FIG. 3. Thereafter, the speakers of the speaker array 104 transmit the pre-coded signals to the user(s).

In one example embodiment and as described above, each speaker of the speaker array 104 transmits a low-energy signal of the audio stream to the users 106 and 108. The low-energy signals, of an audio stream requested by one of the users 106 and 108, from each speaker of the speaker array 104 aggregate in the vicinity of the one of the users 106 and 108 who requested the audio stream such that the energy of the aggregated audio signals of the requested audio stream is above a threshold, and the audio stream becomes more audible to the requesting one of the users 106 and.

In one example embodiment, the threshold described above is a configurable parameter and may correspond to a threshold above which sound is audible to a human ear.

Variations of the example embodiments are not to be regarded as a departure from the spirit and scope of the example embodiments, and all such variations as would be apparent to one skilled in the art are intended to be included within the scope of this disclosure.

What is claimed:

1. A system for localizing an audio stream, the system comprising:
a processor configured to,
determine channel state information of an acoustic channel between a plurality of speakers and at least one device of a plurality of devices, the at least one device requesting the audio stream from among available audio streams; and
determine transmit signals for transmitting audio signals representing the available audio streams to the plurality of devices, the determined transmit signals being based on at least the determined channel state information such that the requested audio stream is more audible to a user associated with the at least one device compared to other users associated with other ones of the plurality of devices.

2. The system of claim 1, wherein the processor is further configured to send the determined transmit signals to the plurality of speakers for transmission to the plurality of devices.

3. The system of claim 1, wherein each of the plurality of speakers transmit the audio signals corresponding to the available audio streams.

4. The system of claim 1, wherein the processor is configured to determine the transmit signals by,
determining pre-codes based on the determined channel state information; and
applying the determined pre-codes and transmission power coefficients to the audio signal to determine the transmit signals.

5. The system of claim 4, wherein the processor is configured to determine the pre-codes based on one of conjugate beamforming or zero-forcing beamforming.

6. The system of claim 1, wherein the processor is configured to determine the channel state information by measuring a channel impulse response between each of the plurality of speakers and the at least one device.

7. The system of claim 6, wherein the processor is configured to measure the channel impulse response by receiving from each of the plurality of speakers, an acoustic training signal transmitted by the at least one device and received at each of the plurality of speakers.

8. The system of claim 7, wherein the acoustic training signal transmitted by the at least one device and other acoustic training signals transmitted by other ones of the plurality of devices are mutually orthogonal.

9. The system of claim 1, wherein the processor is further configured to detect a presence of the at least one device in a setting in which the plurality of speakers are installed.

10. The system of claim 9, wherein the processor is configured to detect the presence of the at least one device by receiving a request for the audio stream from the at least one device.

11. A method for localizing an audio stream, the method comprising:
determining channel state information of an acoustic channel between a plurality of speakers and at least one device of a plurality of devices, the at least one device requesting the audio stream from among available audio streams; and
determining transmit signals for transmitting audio signals representing the available audio streams to the plurality of devices, the determined transmit signals being based on at least the determined channel state information such that the requested audio stream is more audible to a user associated with the at least one device compared to other users associated with other ones of the plurality of devices.

12. The method of claim 11, further comprising:
sending the determined transmit signals to the plurality of speakers for transmission to the plurality of devices.

13. The method of claim 11, wherein each of the plurality of speakers transmit the audio signals corresponding to the available audio streams.

14. The method of claim 11, wherein the determining the transmit signals determines the transmit signals by,
determining pre-codes based on the determined channel state information; and
applying the determined pre-codes and transmission power coefficients to the audio signal to determine the transmit signals.

15. The method of claim 14, wherein the determining the pre-codes determines the pre-codes based on one of conjugate beamforming or zero-forcing beamforming.

16. The method of claim 11, wherein the determining the channel state information determines the channel state information by measuring a channel impulse response between each of the plurality of speakers and the at least one device.

17. The method of claim 16, wherein the measuring measures the channel impulse response by receiving from each of the plurality of speakers, an acoustic training signal transmitted by the at least one device and received at each of the plurality of speakers.

18. The method of claim 17, wherein the acoustic training signal transmitted by the at least one device and other acoustic training signals transmitted by other ones of the plurality of devices are mutually orthogonal.

19. The method of claim 11, further comprising:
detecting a presence of the at least one device in a setting in which the plurality of speakers are installed.

20. The method of claim 19, wherein the detecting detects the presence of the at least one device by receiving a request for the audio stream from the at least one device.
